(19) United States
(12) Patent Application Publication
(10) Pub. No.: US 2026/0334692 A1
(43) Pub. Date: Oct. 29, 2026

(54) CUSHION MEMBER WITH AN AUDIO SYSTEM

(71) Applicant: Jason Jerold Berke, Bloomfield Hills, MI (US)

(72) Inventor: Jason Jerold Berke, Bloomfield Hills, MI (US)

(21) Appl. No.: 19/192,674

(22) Filed: Apr. 29, 2025

(51) Int. Cl. A47C 20/02; A47G 9/10; H04R 1/02; H04R 1/08; H04R 5/02

(52) U.S. Cl. CPC A47C 20/027; A47G 9/1045; A47G 9/1081; H04R 1/025; H04R 1/028; H04R 1/08; H04R 5/023; A47G 2009/1018; H04R 2201/02

(57) ABSTRACT

A husband pillow for ergonomically supporting a user. The husband pillow includes a central supporting pillow having at least two arm support members extending from the central supporting pillow, a neck support member being cylindrical in shape and having an outer surface, and an audio system positioned inside one of the neck support member and central supporting pillow or both.

### FIELD OF THE INVENTION

This application relates to a cushion member that has an audio system.

### BACKGROUND OF THE INVENTION

Cushion members such as pillows have been used to improve the quality and quantity of sleep thereby affecting the mental and physical health and feelings of well-being. There are many types of pillows. For example, husband pillows are pillows that help position an individual erect while lying on the floor or on a bed for reading or watching television. As such, husband pillows are also termed as “reading pillows”, and are designed to support the lower to mid spinal area and the arms of an individual. For example, US patent publication No. 2021/0106157 entitled HUSBAND PILLOW is a husband pillow design to support the spinal and neck regions of a user, and includes an adjustable and removable headrest or neck support and multiple storage compartments for storing one or more objects.

It would be further desirable to provide an improved pillow with additional amenities for the user's enjoyment and comfort.

### SUMMARY OF THE INVENTION

In one aspect of the present invention, a husband pillow for ergonomically supporting a user is provided. The husband pillow includes a central supporting pillow having at least two arm support members extending from the central supporting pillow, a neck support member being cylindrical in shape and having an outer surface, and an audio system positioned inside one of the neck support member and central supporting pillow or both the neck support member and central supporting pillow.

In another aspect of the present invention, a cushion member for ergonomically supporting a user is provided. The cushion member includes an audio system. The audio system includes a speaker positioned in an interior of the cushion member, and a speaker controller operatively connected to the speaker and operative to control the audio aspects of the speaker. The audio system also includes an elongated microphone that extends outwardly from an exterior of cushion member, and a charging cable for connection to a charging unit. The charging unit is operative to provide power to the audio system through the charging cable.

In another aspect of the present invention, an apparatus is provided. The apparatus includes a cushion member for ergonomically supporting a use, an external device, and an audio system operatively connected to the cushion member. The audio system includes a speaker that is positioned in an interior of the cushion member, a microphone, a control module, and a wireless transceiver. The microphone is configured to receive voice input. The control module is operatively connected to the speaker and the microphone. The wireless transceiver is in operative connection with the control module. The wireless transceiver is configured to enable data communication with at least one external device. The control module is configured to process voice commands from the microphone and perform one or more tasks on the external device. The one or more task may be selected from audio playback, smart assistant responses, audio routing for gaming communications, or interaction with smart home devices.

Other aspects of the cushion member with an audio system will become apparent from the following detailed description, the accompanying drawings and the appended claims.

### BRIEF DESCRIPTION OF THE DRAWINGS

FIG. 1 is a front and right perspective view of a cushion member in the form of a husband pillow, according to the embodiment of the present invention.

FIG. 2 is a front elevation view of the husband pillow of FIG. 1.

FIG. 3 is a rear elevation view of the husband pillow of FIG. 1.

FIG. 4 is a right-side elevation view of the husband pillow of FIG. 1.

FIG. 5 is a front and left perspective view of the husband pillow of FIG. 1 and with hidden lines illustrating elements of the husband pillow.

FIG. 6 is partially exploded view of a neck support member of the husband pillow of FIG. 1 including related elements and with portions removed for illustrated purposes.

FIG. 7 is a perspective view of components of the husband pillow of FIG. 1.

FIG. 8 front perspective view of the neck support member of the husband pillow of FIG. 1 being spaced from a top portion of the central support pillow of the husband pillow of FIG. 1.

FIG. 9 shows a perspective view of an arrangement of a cushion member of another embodiment of the present invention with the husband pillow of FIG. 1.

FIG. 10 shows a schematic block diagram of an apparatus that has a cushion member with a smart audio system according to another embodiment of the present invention.

FIG. 11 shows a front and right perspective view of a cushion member in the form of a husband pillow and with hidden lines illustrating elements of the husband pillow, according to another embodiment of the present invention.

FIG. 12 shows a front perspective view of another embodiment of a cushion member of the present invention and with hidden lines illustrating elements of the cushion member.

FIG. 13 shows a rear perspective view of another embodiment of a cushion member of the present invention and with hidden lines illustrating elements of the cushion member.

### DETAILED DESCRIPTION OF THE INVENTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

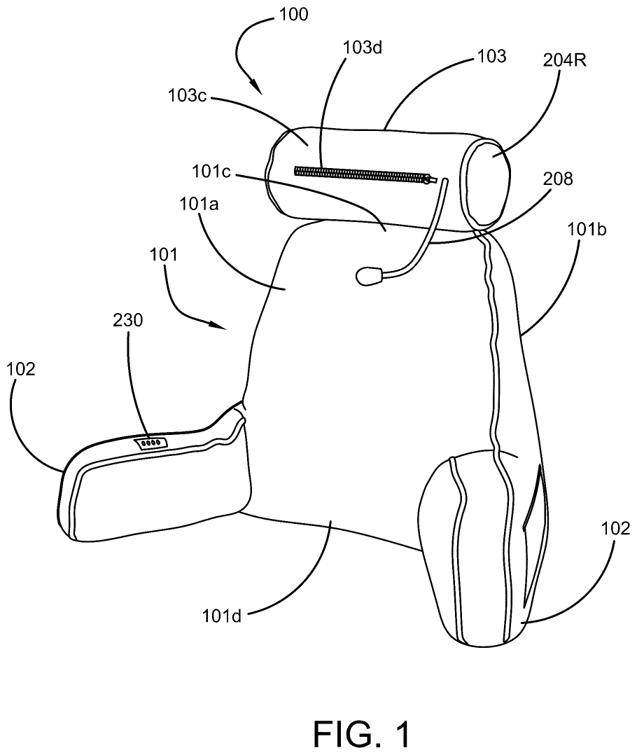

Throughout the present description, the terms “upper”, “lower”, “top”, “bottom”, “left”, “right”, “front”, “forward”, “rear”, and “rearward” shall define directions or orientations with respect to the pillow as illustrated in FIG. 1, which is a front and right perspective view of the pillow. It will be understood that the spatially relative terms “upper”, “lower”, “top”, “bottom”, “left”, “right”, “front”, “forward”, “rear”, and “rearward” are intended to encompass different orientations of the pillow in use or operation in addition to the orientation depicted in the figures.

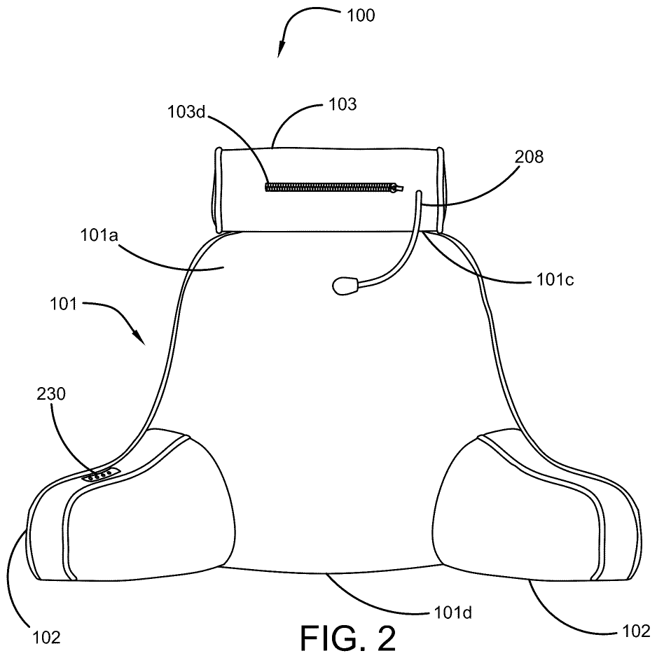

FIG. 1 illustrates a front perspective view of a cushion member in the form of a husband pillow 100, according to an embodiment of the present invention. FIG. 2 illustrates a front elevation view of the husband pillow 100. The husband pillow 100 for ergonomically supporting a user includes a central support pillow 101, at least two arm support members 102, and a neck support member 103. The central support pillow 101 includes a front surface 101a, a rear surface 101b, a top surface 101c, and a bottom surface 101d. In an embodiment, the exterior of the central support pillow 101, the arm support members 102, and the neck support member 103 is ma105de of a natural or synthetic fiber, for example, polyester, rubber, cotton, etc.

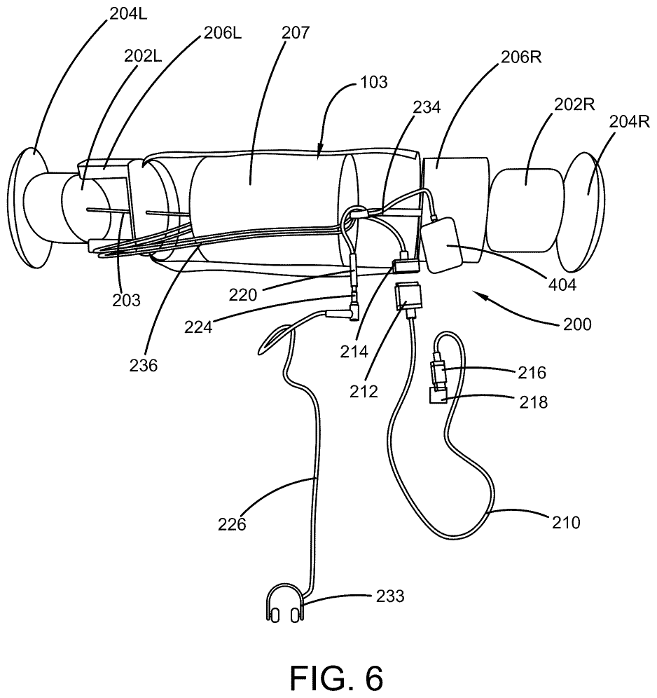

Further, the interior of the central support pillow 101, the arm support members 102, and the neck support member 103 are made of filler materials, for example, foam, cotton, poly-fill, memory foam, Styrofoam beads, etc. The filler materials may also include a combination of gases and foam or only include gases. Other filler materials may include air bladders, inflatable compartments, gel-based filler, and combinations thereof. In one embodiment, the neck support member 103 is generally cylindrical in shape extending axially and having fabric end portions 204L, 204R (FIG. 6) at each axial end of the neck support member 103. The neck support member 103 also has an outer surface 103c and a zip fastener or zipper 103d along the outer surface 103c to allow the filler materials and components to be removed from an interior thereof. The zipper 103d may be on the front (as shown in the FIG. 1) or rear or any other location of the outer surface 103c of the neck support member 103. The zipper 103d may also be located on the outer surface of the central support member 101 or arm support members 102. The central support pillow 101 and the arm support members 102 are a single compact unit and the external fiber provides an airtight seal to the filler material contained within.

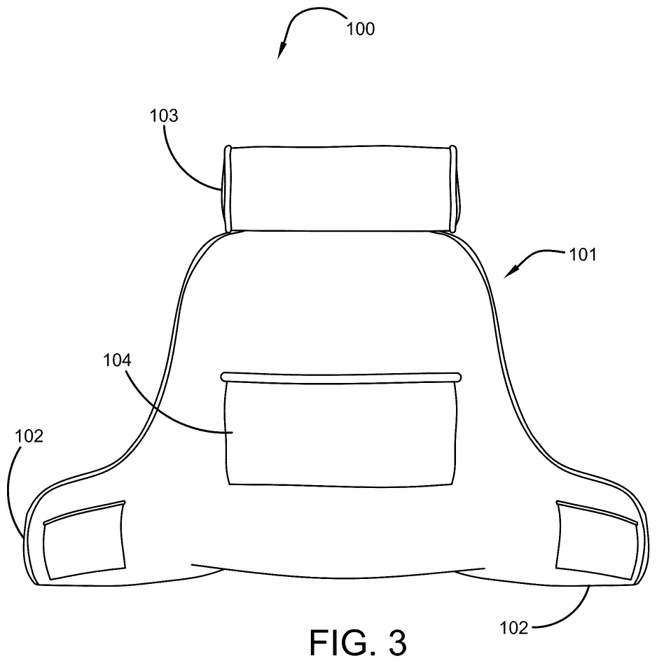

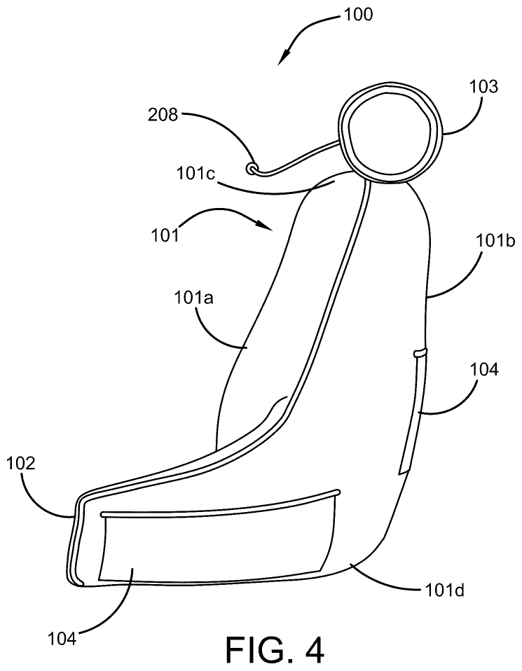

The front surface 101a of the central support pillow 101 is configured to contact the back of the user and conform to the back of the user. The at least two arm support members 102 extend outward from the front surface 101a of the central support pillow 101. In an embodiment, the at least two arm support members 102 are positioned proximal to the bottom surface 101d of the central support pillow 101 to support the arms of the user. A plurality of storage compartments 104 is configured on the at least two arm support members 102 and the central support pillow 101 for storing one or more objects as exemplarily illustrated in FIGS. 3 and 4. An optional RFID-blocking pocket or hidden pocket may be provided in the pillow 100. The neck support member 103 may be detachably attached to a top surface 101c of the central support pillow 101 to support a neck of the user by any suitable way.

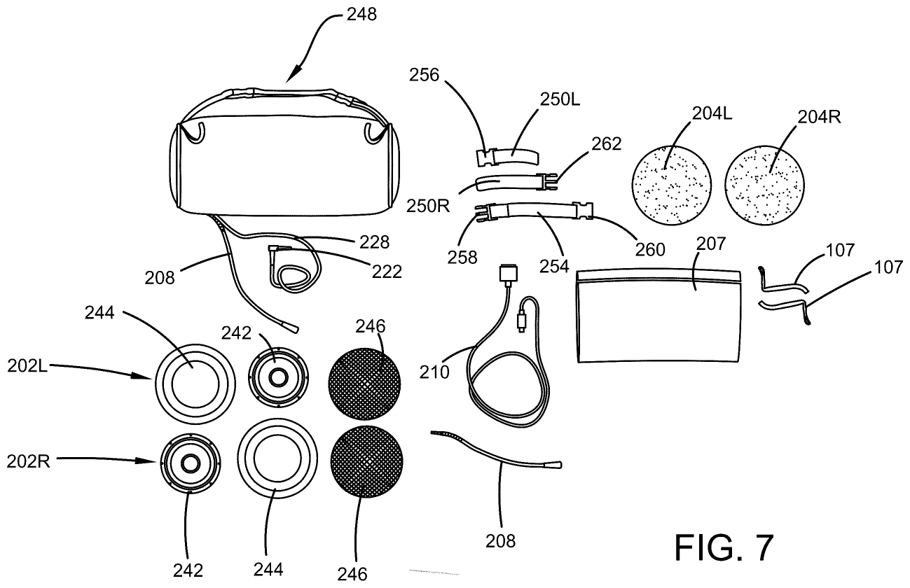

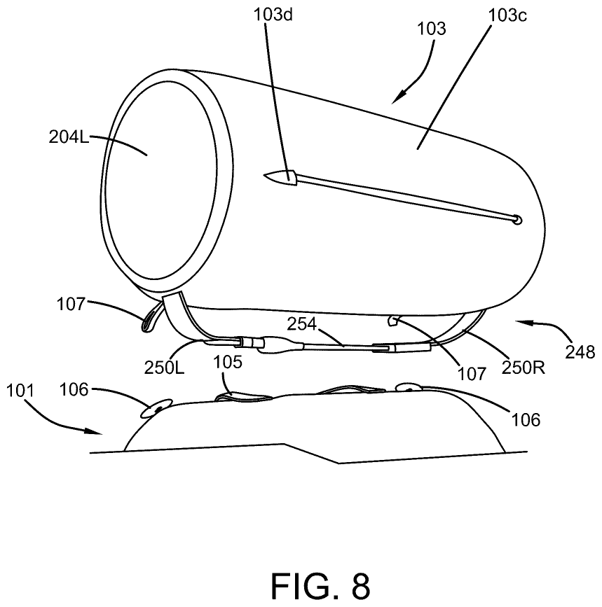

As depicted in FIGS. 7 and 8, the husband pillow 100 may include a closed loop or carrying handle 248 attached by a suitable mechanism such as stitching to the neck support member 103. The carrying handle 248 may include right and left straps 250R, 250L that are releasably attached by buckles to a middle strap 254 located between them. In particular, the left strap 250L has one end attached near the left axial end of the neck support member 103 and the other end defining a female male buckle end 256 that releasably receives a male buckle end 258 of the middle strap 254. The other end of the middle strap 254 defines a female buckle end 260 that releasably receives a male buckle end 262 of the right strap 250R. The other end of the right strap 250R is attached near the right axial end of the neck support member 103. As seen in FIGS. 1-4, the front surface 101a of the central support pillow 101, the at least two arm support members 102, and the neck support member 103 ergonomically support the back, the arms, and the neck of the user respectively to provide a comfortable position when a user is laying down or partially seated. In an embodiment, the arm support members 102 are positioned at an angle, for example, around 90-120 degrees, relative to the central support pillow 101.

FIG. 3 exemplarily illustrates a rear elevation view of the husband pillow 100. FIG. 4 exemplarily illustrates a right-side elevation view of the husband pillow 100. In an embodiment, the storage compartments 104 are configured on the rear surface 101b of the central support pillow 101 and the outer surfaces of the arm support members 102 as exemplarily illustrated in FIGS. 3 and 4. The storage compartments 104 store one or more objects, for example, headphones, e-book readers, laptops, remotes of nearby appliances, spectacles, etc. The storage compartments 104 may be open pouches or pockets or sealable compartments having zip fasteners to seal the storage compartment 101. The husband pillow 100 may include a closed loop or handle 105 (FIG. 8) attached by a suitable mechanism such as stitching to the central support pillow 101. The husband pillow 100 may entirely be housed within a removable fabric cover that can be washed periodically to prevent dirt from accumulating on the surface of the husband pillow 100. The neck support member 103 is detachably attached to the top surface 101c of the central support pillow 101. In an embodiment, the neck support member 103 is adjustable and detachably attached using one or more attachment members 107 (FIG. 8) such as snap fasteners, hook and loop fasteners, bungee cords, or drawstrings. In an embodiment, the attachment members 107 are elongated and define looped hooks. In an embodiment, the attachment members 107 are flexible and may be stretchable.

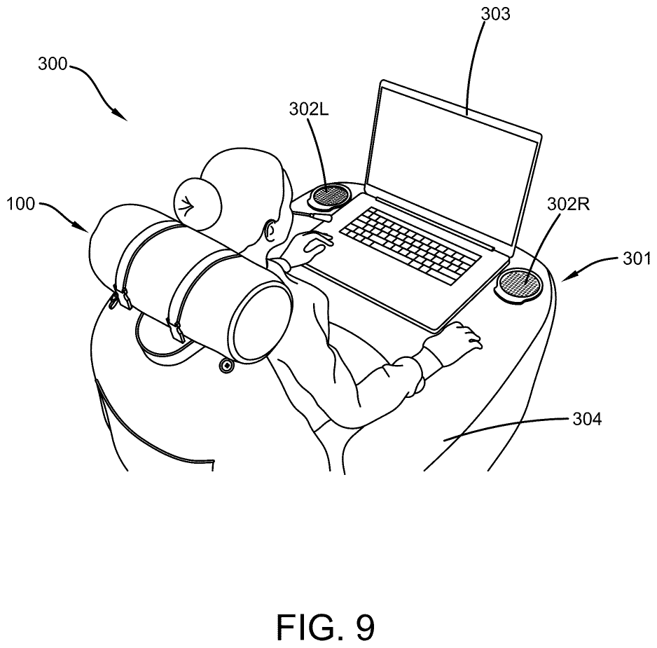

The neck support member 103 may be adjusted relative to the top surface 101c of the central support pillow 101 and positioned downwardly in various positions such as that disclosed by US patent application number 20210106157, the disclosure of which is incorporated by reference in its entirety. As seen in FIGS. 7 and 9, the husband pillow 100 includes one or more anchors 106 at fixed positions on the central support pillow 101. In one embodiment, the anchors 106 may be a button attached by a suitable mechanism such as stitching to the central support pillow 100. As illustrated in FIG. 8, the anchors 106 are at fixed positions along the top surface 101 and a side surface of the central support pillow 101. The attachment members 107 are attached to the anchors 106 by looping around the anchors 106. In one embodiment, the husband pillow 100 may include an adjuster on the attachment member 107 such as that disclosed by US patent application number 20210106157 to allow an adjustable length of the attachment member 107. The attachment member 107 may be fixed in length by a suitable mechanism such as stitching such that the end of the attachment member 107 extends beyond the anchor 106. As disclosed by US patent application number 20210106157, the attachment member 107 may extend through the adjustor and a hand of a human operator may be used to compress the adjustor and allow the length of the attachment member 107 to be adjusted to remove or apply the attachment member 107 about the anchor 106. It should be appreciated that when the adjustor is released by the hand of the human operator the length of the attachment member 107 is fixed.

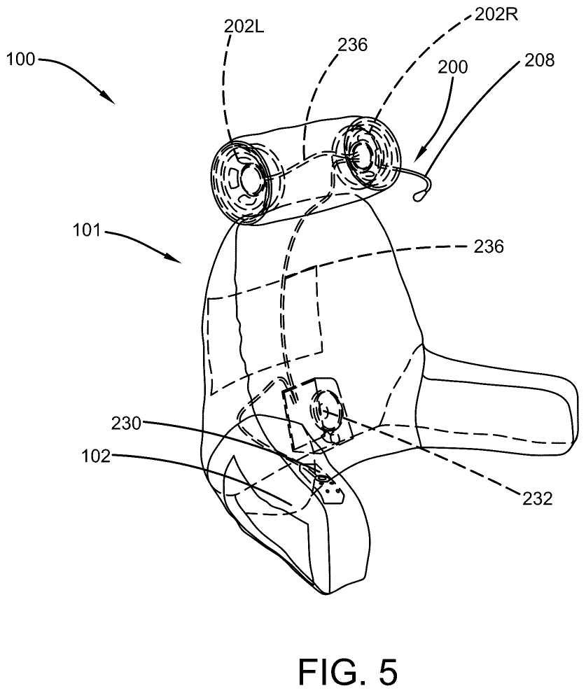

Referring to FIGS. 5-7, the husband pillow 100 may include an audio system 200 integrated with the pillow 100. As illustrated in FIG. 6, the audio system may include left and right cylindrical speakers 202L, 202R located inside the neck support member 103 and located at opposite left and right axial ends of the neck support member 103. The speakers 202L, 202R may be covered by the axial fabric end portions 204L, 204R of the neck support member 103. Each of the speakers 202L, 202R may be a Bluetooth speaker, a smart speaker, integrated WiFi and Bluetooth combination speaker, or any other suitable type. As illustrated in FIG. 7, each of the speakers 202L, 2022R, may comprise a cone 242 mounted on a cylindrical base 244 and covered by a mesh cover 246. Each of the speakers 202L, 202R faces its respective axial fabric end portions 204L, 204R so that the sound is outputted through the axial fabric end portions 204L, 204R. The left and right speakers 202L, 202R may be positioned to create a stereo audio effect for the user. The audio system 200 may be positioned to provide localized audio output to the user's head when the user is reclining against the central support pillow 101.

As seen in FIG. 6, the left and right speakers 202L, 202R may be received within, or disposed in recesses 203 of respective cylindrical speaker support members 206L, 206R of the neck support member 103 located inside the neck support member 103. The speaker support members 206L, 206R enclose their respective speakers 202L, 202R except at outer axial ends of the speakers 202L, 202R, which are covered by the axial fabric end portions 204L, 204R. A cylindrical middle support member 207 may be located inside the neck support member 103 and between the speaker support members 206L, 206R. The cylindrical speaker support members 206L, 206R and middle support member 207 may be made of memory foam or other suitable cushion material such a viscoelastic polymer to enhance the comfort of the user. The speaker support members 206L, 206R may be sound-dampening speaker support members or formed as an integral part of the neck support member 103. The audio system 200 may also include a microphone 208 (FIGS. 5 and 7). The microphone 208 may be elongated and have an adjustable length. The microphone 208 may also comprise a deformable type material that allows the microphone to bend or fold to a desirable orientation. The microphone 208 may also be retractable or pivotable and stowable within a compartment of the neck support member 103. The microphone 208 may be in the form of a pivot arm, removable boom, or be stowed in hidden compartments of the pillow 100. The microphone 208 may include noise cancellation capability and directionality. As seen in FIGS. 6 and 7, the audio system 200 may include a charging cable 210. The charging cable 210 may include a male magnetic connector 212 on one end that receives and magnetically connects to a female magnetic connector 214 of opposite polarity, and a USB-C male connector 216 or other suitable connector on the other end for connection to a charging unit 218. The charging unit 218 may utilize inductive charging or magnetic charging. Power supplied to the audio system may include an inductive charging mat in the base, solar integration, or an external battery pack that's user-replaceable. Low-power modes, auto-shutoff, or battery management features may also be provided.

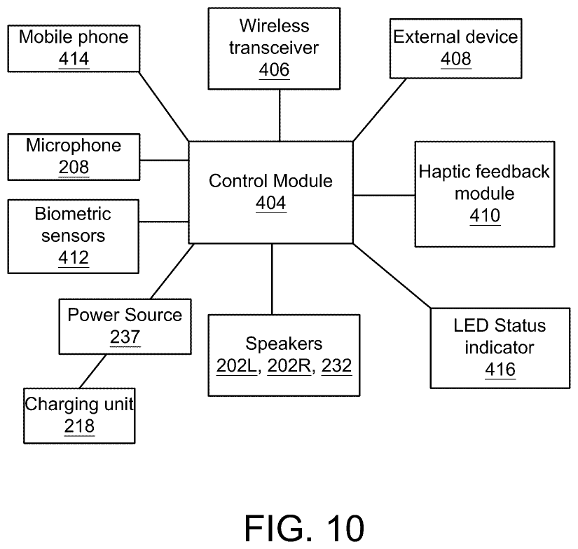

As seen in FIG. 6, the audio system 200 may include an audio auxiliary socket 220 for connection to a jack 224 of a cable 226 that is coupled to an audio product such as a headphone 233 or another microphone. The audio system 200 may additionally include an audio jack console connector 228 (FIG. 7) that has a jack 222 on its free end for connection to a socket of an audio source or audio product such as a headphone or another microphone. A woofer or subwoofer speaker 232 may be provided in the lower central portion of the central support pillow 101 as seen in FIG. 5. The cylindrical speakers 202L, 202R and subwoofer speaker 232 are electrically connected to a speaker controller 230 via connection cables 236. The speaker controller 230 may be positioned on one of the arm support members 102 of the pillow 100 such as the left arm support member (FIG. 1). The speaker controller 230 may be configured to control various audio aspects of the cylindrical speakers 202L, 202R and subwoofer speaker 232 such as power (on/off), volume, tone, balance, etc., or a user defined audio profile. AI-based audio tuning may be provided that adjusts output of one more of the speakers based on proximity sensors or room acoustics. The connection cables 236 are also electrically coupled to the audio auxiliary socket 220, female magnetic connector 214, audio jack console 228, speaker controller 230, and microphone 208 and all are joined together at a junction unit 234. The junction unit 234 may comprise a power source 237 (FIG. 10) for the components of the audio system 200 in the form of a rechargeable battery that can be charged by the charging unit 218 through the charging cable 210.

The connector cables 236, auxiliary socket 220, and female magnetic connector 214 are located inside the neck support member 103. The zipper 103d may be opened to enable access to these components and closed to prevent access to these components. The zipper 103d may be opened to enable the microphone 208 to be folded and inserted into the neck support member 103 and also to allow other components such as the audio jack console connector 228, the speaker controller 230, and charging cable 210 to be inserted into the neck support member 103 if desired. The zipper 103d can then be closed to prevent these components from falling out of the neck support member 103. To operate the audio system, the male magnetic connector 212 is inserted into and magnetically connected to the female magnetic connector 214, and the USB-C male connector 216 is connected to a corresponding female USB-C connector of the charging unit 218. The power source 237 powers on the speakers 202L, 202R, 232, speaker controller 230, auxiliary socket 220, microphone 208, and audio jack console connector 228. Alternatively, if the rechargeable battery is provided and charged to provide power to the audio system 200, the speaker controller 230 may be configured to turn on or off and control the audio aspects of all of the components of the audio system 200. Alternatively, the outer cover of the husband pillow may include a built-in inductive wireless charging receiver pad. Additional or alternative power sources 237 and/or charging methods may include an inductive charging mat in the base, solar integration, solar powered battery as the power source 237, house current as the power source 237 or an external battery pack that's user-replaceable as the power source 237.

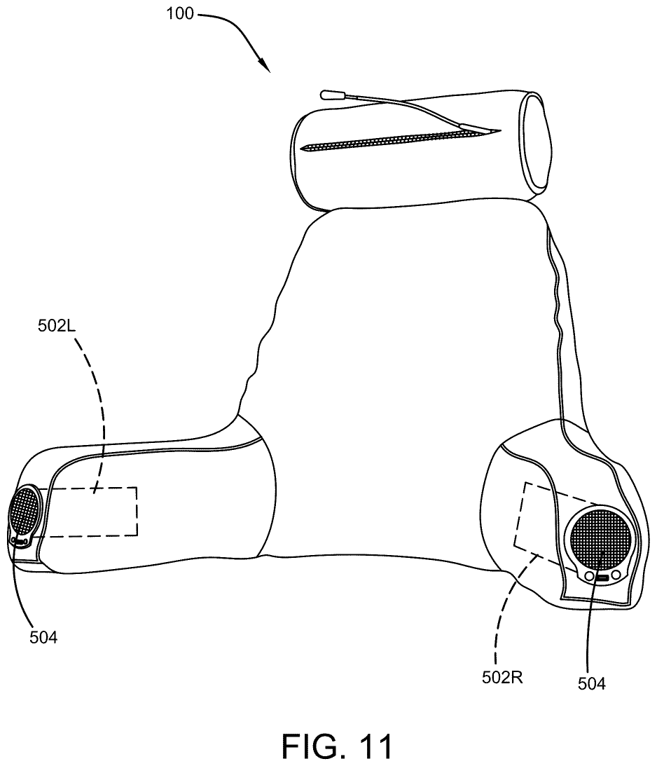

Also, upon connecting the jack 222 to a headphone or connecting the jack 224, which is connected to a headphone 233, to the auxiliary socket 220, the audio system 200 may prevent sound from being outputted by the speakers 220L, 220R, and 232. Alternatively, the speaker controller 230 may be configured to also operate the microphone 208, headphone 233, and other components of the audio system independently from each other. In certain embodiments, the husband pillow does not include a neck support member and one or more speakers are disposed within the back portion of the pillow or within one or both arm support members. In alternative embodiments, when a neck support member is provided, the speakers may be positioned within the neck support member, the arms, or any combination thereof. The invention is not limited to “husband pillows” only—it can be “any reading or backrest pillow with arms or other types of cushion members. FIG. 11 shows an embodiment of a husband pillow 100 that is similar to the embodiment of FIG. 1 except for the following. In this embodiment, speakers 502L, 502R (schematically shown) are located in the arm support members 102 and operatively connect to the power source 237. Specifically, each speaker is located near the front side of its respective arm support member 102. Each speaker has a meshed speaker cover 504 made of a rigid material such as a plastic or metal that covers the output of its respective speaker. The neck support member 103 may also have speakers located therein as those previously mentioned for FIG. 1, or alternatively have no speakers located therein. All of the other components of this embodiment are similar in structure and function as that of the embodiment of FIG. 1.

Other types of cushion members can include one or more components of the audio system. For example, the speakers 302L, 302R may be incorporated into an interior of a cushioned table 301 at the top surface of the cushion table 301 near the rear edge of the cushioned table 301 and face upward as shown in FIG. 9. Alternatively, the speakers 302L, 302R may be placed in a variety of other locations depending on user preference, ergonomic considerations, or desired audio direction. For example, the speakers 302L, 302R may be placed on the rear (back side) of the cushioned table 301 (facing the user's torso or away from it), the front edge (facing outward toward the user's legs), and side edges. The cushioned table 301 may be part of a workspace arrangement 300 in which a user places his or her laptop 303 on top of the cushioned table 301, sits against the husband pillow 100, places her legs under the cushioned table 301, and operates the laptop 303. The cushioned table 310 may have right and left arm rests 304 that extend forwardly from the front end of the cushioned table 301 for the user to support his or her arms. The shape can be rectangular, contoured, or have arm rests. Other types of cushion members that have other shapes (e.g., contoured, square, flattened), which are useful for ergonomic/gaming models maybe provided. The cushioned table 301 can have an integrated or detachable speaker module. Also, the speakers may have integrated or detachable heads. All of the other components of this embodiment are similar in structure and function as that of the embodiment of FIG. 1 of the present invention.

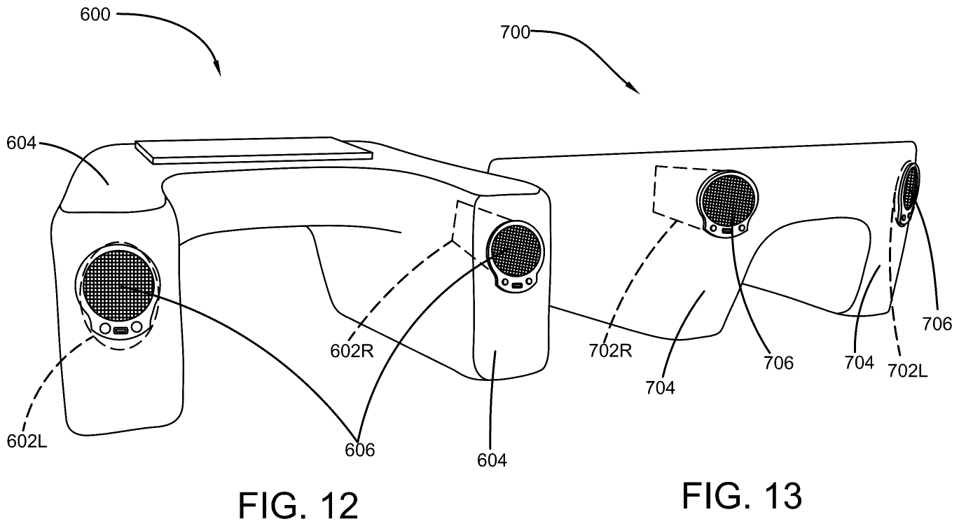

FIG. 12 shows an embodiment of a cushioned table 600 that is similar to the embodiment of FIG. 1 except for the following. In this embodiment, speakers 602L, 602R (schematically shown) are located in the arm rests 604 and operatively connect to the power source 237. Specifically, each speaker is located near the front side of its respective arm rest 604. Each speaker has a meshed speaker cover 606 made of a rigid material such as a plastic or metal that covers the output of its respective speaker. The cushioned table 600 may also have speakers located at the top of the cushioned table 600 such as those previously mentioned for FIG. 9, or alternatively have no speakers located there. All of the other components of this embodiment are similar in structure and function as the cushioned table 301 of the embodiment of FIG. 9 of the present invention.

FIG. 13 shows an embodiment of a cushioned table 700 that is similar to the embodiment of FIG. 1 except for the following. In this embodiment, speakers 702L, 702R (schematically shown) are located in the arm rests 704 and operatively connect to the power source 237. Specifically, each speaker is located near the front side of its respective arm rest 704. Each speaker has a meshed speaker cover 706 made of a rigid material such as a plastic or metal that covers the output of its respective speaker. The cushioned table 700 may also have speakers located at the top of the cushioned table 700 such as those previously mentioned for FIG. 9, and/or at the front of the arm rests 704 such as those previous mentioned for FIG. 12, or alternatively have no speakers located there. All of the other components of this embodiment are similar in structure and function as the cushioned table 301 of the embodiment of FIG. 9 of the present invention.

In certain embodiments, the audio system may be a smart audio system that is configured to receive, interpret, and respond to user voice commands. The module may include a voice assistant system, such as a proprietary AI system or integration with third-party systems (e.g., Alexa®, Siri®, or Google Assistant™). The microphone and audio system may be configured to operate in low-latency mode, suitable for real-time gaming communication or video conferencing. Noise-cancellation and beamforming may be provided to isolate the user's voice. In some embodiments, directional microphone arrays may be provided in the cushion member to isolate user voice input. The audio system may have a dual-mic array for team chat or noise cancellation. The pillow may connect to gaming consoles (Xbox, PS, Nintendo) or PC via Bluetooth, Wi-Fi, or proprietary protocols. Low-latency protocols (e.g., aptX Low Latency, Wi-Fi direct) for console gaming or PC gaming may be provided. The gaming console may have a wired console connection (e.g., headphone jack) for zero latency.

FIG. 10 schematically illustrates an exemplary embodiment of an apparatus 400 that comprises a smart audio system 402 that is operatively connected to the pillow 100. The smart audio system may comprise a control module 404 (FIGS. 6 and 10), a wireless transceiver 406, and one or more eternal devices 408. The control module 404 may be positioned near the neck support member 103. The control module may have a wireless transceiver, memory, and processor to handle voice assistants. The control module 404 is operatively connected to the speakers 202L, 202R, 232 and the microphone 208. The wireless transceiver 406 is in operative connection with the control module 404 and is configured to enable data communication with the external device 408. The external device 408 may be a gaming console, a virtual reality headset, a smart home device, a computing device or any combination thereof. Essentially, the external device 408 may be any device that pairs wirelessly with the smart audio system for communication or functionality. The control module 404 is configured to process voice commands form the microphone 208 and perform one or more tasks on the external device 408. The control module 404 and related elements may also be included in the pillows 300 shown in the embodiments of FIGS. 9 and 11-13.

These tasks may be selected from audio playback, smart assistant responses, audio routing for gaming communications, or interaction with smart home devices. A haptic feedback module 410 may be operatively connected to the control module and configured to provide vibrational cues corresponding to audio or user input. Biometric sensors 412 may be integrated into the pillow 100 and may be configured to detect temperature, posture, or heart rate data of the user sitting in the pillow 100. A mobile phone 414 such as a smartphone may be operatively connected by wire or wireless to the control module 404 and can be used to operate the external device 408 and/or the speakers 202L, 202R, 232 and microphone 208. The smartphone 414 may be operative to play music through the speakers, make calls, or interact with a smart assistant. The smartphone 414 may have optional inline controls (e.g., volume, track skipping) or purely phone-based controls. The wireless transceiver 406 may be configured to communicate with a mobile application on the smartphone 414 for controlling audio settings, firmware updates, and audio profiles. An LED status indicator 416 may provided on the exterior surface of the pillow 100, speaker controller 230 or other visible part and operatively connected to the control module 404 to display power, connection, or operating mode. The audio system 200 might store a small OS or firmware, handle OTA updates, or run on a microcontroller or SoC. The pillow 100 can connect to electrical devices via Bluetooth, Wi-Fi (2.4 GHz/5 GHz), or other protocols (Zigbee, NFC).

In one embodiment, the audio and electronic components are housed in a swappable modular core that fits within an interior compartment of the neck support member 103. This enables easy removal for cleaning or upgrading electronic components. The audio system 200 may be powered by a rechargeable lithium-polymer battery or by an inductive charging system embedded within the base or rear portion of the pillow 100. The system may include energy-saving modes or auto-shutoff features when not in use.

Below is one example of the smart audio system 402 operating a game on an external device in the form of a gaming console 408. First, a user says “Start the racing game” into the microphone 208. The control module 404 activates the gaming console 408 and a game display output turns on in response to this voice command. The user then says “Accelerate” into the microphone 208. The control module 404 sends a command to the game console 408 to cause the user's racing car in the game to accelerate on the display. During rough terrain or crashes, the control module 404 may cause the haptic feedback module 410 to vibrate. The audio system 402 may incorporate cloud-based speech recognition, AI-based local processing, multi-user voice profiles, and automated volume leveling or equalization.

Although various embodiments of the disclosed cushion member having an audio system have been shown and described, modifications may occur to those skilled in the art upon reading the specification. The present application includes such modifications and is limited only by the scope of the claims.

What is claimed is:

1. A husband pillow for ergonomically supporting a user comprising:
a central supporting pillow having at least two arm support members extending from the central supporting pillow;
a neck support member being cylindrical in shape and having an outer surface; and
an audio system positioned inside one of the neck support member and the central supporting pillow or both the neck support member and the central supporting pillow.

2. The husband pillow of claim 1, wherein the audio system comprises at least a first speaker, wherein the first speaker is positioned inside the neck support member and faces a first axial end portion of the neck support member.

3. The husband pillow of claim 2 further comprising a first speaker support member, wherein the first speaker support member is positioned inside the neck support member, wherein the first speaker is at least partially enclosed by the first speaker support member, wherein the first speaker support member is made of cushion material.

4. The husband pillow of claim 3, wherein the first speaker support member is made of memory foam, wherein the audio system further comprises a second speaker, wherein the husband pillow further comprises a second speaker support member and a middle support member, wherein the second speaker support member and the middle support member are positioned inside the neck support member and made of memory foam, wherein the second speaker is positioned inside the neck support member and faces a second axial end portion of the neck support member opposite the first axial end portion, wherein the second speaker is at least partially enclosed by the second speaker support member, wherein the middle support member is located between the first and second speakers, wherein the first and second speakers are positioned to create a stereo audio effect for the user.

5. The husband pillow of claim 2, wherein the audio system comprises a speaker controller, wherein the speaker controller is operatively connected to the speaker and configured to control at least one of power (on/off), volume, tone, balance, and a user-defined audio profile of the speaker or any combination of power (on/off), volume, tone, balance, and a user-defined audio profile of the speaker.

6. The husband pillow of claim 2, wherein the audio system comprises a second speaker, wherein the second speaker is positioned in the central supporting member.

7. The husband pillow of claim 1, wherein the audio system comprises a microphone.

8. The husband pillow of claim 1, wherein the audio system comprises a charging cable for connection to a charging unit and a power source for providing power to the audio system, wherein the charging unit is operative to charge the power source through the charging cable.

9. The husband pillow of claim 1, wherein the audio system comprises an audio auxiliary socket for connection to a jack, wherein the jack is operatively connected to an audio product.

10. The husband pillow of claim 1, wherein the audio system comprises a cable, wherein the cable includes a jack for connection to an audio product.

11. The husband pillow of claim 1, wherein the audio system comprises:
a speaker, wherein the speaker is positioned inside the neck support member and faces an axial end portion of the neck support member;
a speaker controller, wherein the speaker controller is operatively connected to the speaker and operative to control at least one of power (on/off), volume, tone, balance, and a user-defined audio profile of the speaker or any combination of the power (on/off), volume, tone, balance, and a user-defined audio profile of the speaker;
a microphone, wherein the microphone is elongated and extends outwardly from the neck support member; and
a charging cable for connection to a charging unit, wherein the charging unit is operative to charge a power source through the charging cable, wherein the power source is operative to provide power to the audio system.

12. The husband pillow of claim 11, wherein the audio system comprises a cable, wherein the cable includes a jack for connection to an audio product.

13. The husband pillow of claim 11, wherein the charging cable is magnetically connected to the audio system.

14. A husband pillow as set forth in claim 1 wherein the neck support member includes a zipper provided along an outer surface of the neck support member, wherein the zipper is configured to allow filler materials and components to be removed from an interior of the neck support member.

15. A cushion member for ergonomically supporting a user comprising:
an audio system, wherein the audio system comprises:
a speaker, wherein the speaker is disposed in an interior of the cushion member;
a speaker controller, wherein the speaker controller is operatively connected to the speaker and operative to control at least one of power (on/off), volume, tone, balance, and a user-defined audio profile of the speaker or any combination of the power (on/off), volume, tone, balance, and a user-defined audio profile of the speaker;
a microphone, wherein the microphone is elongated and extends outwardly from an exterior of the cushion member; and
a charging cable for connection to a charging unit, wherein the charging unit is operative to charge a power source through the charging cable, wherein the power source is operative to provide power to the audio system.

16. An apparatus comprising:
a cushion member for ergonomically supporting a user;
at least one external device; and
an audio system operatively connected to the cushion member, wherein the audio system comprises:
a speaker, wherein the speaker is positioned in an interior of the cushion member;
a microphone, wherein the microphone is configured to receive voice input;
a control module, wherein the control module is operatively connected to the speaker and the microphone; and
a wireless transceiver in operative connection with the control module, wherein the wireless transceiver is configured to enable data communication with the external device, wherein the control module is configured to process voice commands form the microphone and perform one or more tasks on the external device, wherein the one or more task may be selected from audio playback, smart assistant responses, audio routing for gaming communications, or interaction with smart home devices.

17. The apparatus of claim 16, wherein the external device is one of a gaming console, a virtual reality headset, a computing device or any combination thereof.

18. The apparatus of claim 16, wherein the audio system comprises a haptic feedback module operatively connected to the control module and configured to provide vibrational cues corresponding to audio or user input.

19. The apparatus of claim 16 further comprising one or more biometric sensors integrated into the cushion member, wherein the one or more biometric sensors are configured to detect temperature, posture, or heart rate data of the user.

20. The apparatus of claim 16 further comprising:
a central supporting pillow having at least two arm support members extending from the central supporting pillow;
a neck support member, wherein the audio system is positioned inside one of the neck support member and the central supporting pillow.
